(19) United States
(12) Patent Application Publication
(10) Pub. No.: US 2013/0180881 A1
(43) Pub. Date: Jul. 18, 2013

(54) MULTI-SHAPE MEMORY CONTAINER

(71) Applicant: Hong-Xiang Jin, New Taipei City (TW)

(72) Inventor: Hong-Xiang Jin, New Taipei City (TW)

(21) Appl. No.: 13/805,356

(22) PCT Filed: Aug. 5, 2011
(86) PCT No.: PCT/CN11/01286

§ 371 Date: Apr. 2, 2013

(30) Foreign Application Priority Data
Aug. 5, 2010 (CN) 201020283287.0

(51) Int. Cl. G06F 1/18

(52) U.S. Cl. CPC G06F 1/181
USPC 206/723

(57) ABSTRACT

A multi-shape memory container includes a body made of soft silicone. The body is provided with a recessed cavity into which a memory product is embedded. A front end of the body is formed by a first cover board, a second cover board, and a receiving space formed inside the two cover boards. A slot is formed between the first and the second cover boards. After the memory product is placed in the recessed cavity, a Universal Serial Bus (USB) connector thereof is exposed in the receiving space and protected by the two cover boards. In use, the two cover boards are flipped open to expose the USB connector out of the body (10). The USB connector is hidden inside the body, so that not only simplicity, convenience, and an excellent protective effect are achieved, but also bodies of various shapes may be used according to a user's preferences.

### FIELD OF THE INVENTION

The present invention relates to a multi-shape memory container.

### BACKGROUND OF THE INVENTION

Universal Serial Bus (USB) is generally used as a connector for storing and transmitting data, and extensively applied in flash memory devices. However, a memory body and a USB connector of the flash memory devices usually come with no housing or cover for protection. Most USB connectors are covered by a removable cover, and users have to remove the cover before use. Such removable cover has a small volume and may be lost or missing easily, so that users have to put attention to where the cover is put, and thus causing tremendous inconvenience to the users. To overcome this problem, some manufacturers design a cover integrally formed with the memory product. During use, the cover is separated from the USB connector and still coupled to the memory product to overcome the aforementioned problem. However, such design incurs a high cost and comes with a monotonous appearance and fails to become a popular design.

### SUMMARY OF THE INVENTION

Therefore, it is a primary objective of the present invention to provide a multi-shape memory container with different appearances and a protection function.

To achieve the aforementioned objective, the present invention provides a multi-shape memory container, comprising: a body made of soft silicone and having a recessed cavity formed thereon for embedding a memory product therein; a first cover board and a second cover board formed on both sides of a front end of the body respectively to define a receiving space therein; and a slot formed between the first cover board and the second cover board. The multi-shape memory container is made of rubber, not only can be designed with various different shapes, but also can be provided as an item such as a hanging decorator, a keychain or any portable item with a shape changeable according to user preference. In addition, the multi-shape memory container is provided for embedding a memory product in the recessed cavity of the body, and the elasticity of the soft silicone can be used for fixing the flash memory device. Two cover boards of the body can be used for hiding the USB connector inside, and a slot with a small gap is formed between the two cover boards, and the two cover boards can be flipped open to expose the USB connector for use.

Preferably, the body has a hole protruded outwardly from an end of the body for hanging a keychain or a hanging decorator.

Preferably, the rear end of the slot is aligned precisely with the recessed cavity.

### BRIEF DESCRIPTION OF THE DRAWINGS

FIG. 1 is a perspective view of the present invention;

FIG. 2 is a schematic view of FIG. 1;

FIG. 3 is a cross-sectional view of FIG. 1;

FIG. 4 is a schematic view of plugging a memory product of the present invention;

FIG. 5 is a schematic view of a using status of the present invention;

FIG. 6 is a is a perspective view of another embodiment of the present invention; and

FIG. 7 is a cross-sectional view of FIG. 6.

### DESCRIPTION OF THE PREFERRED EMBODIMENTS

The technical contents of the present invention will become apparent with the detailed description of preferred embodiments accompanied with the illustration of related drawings as follows.

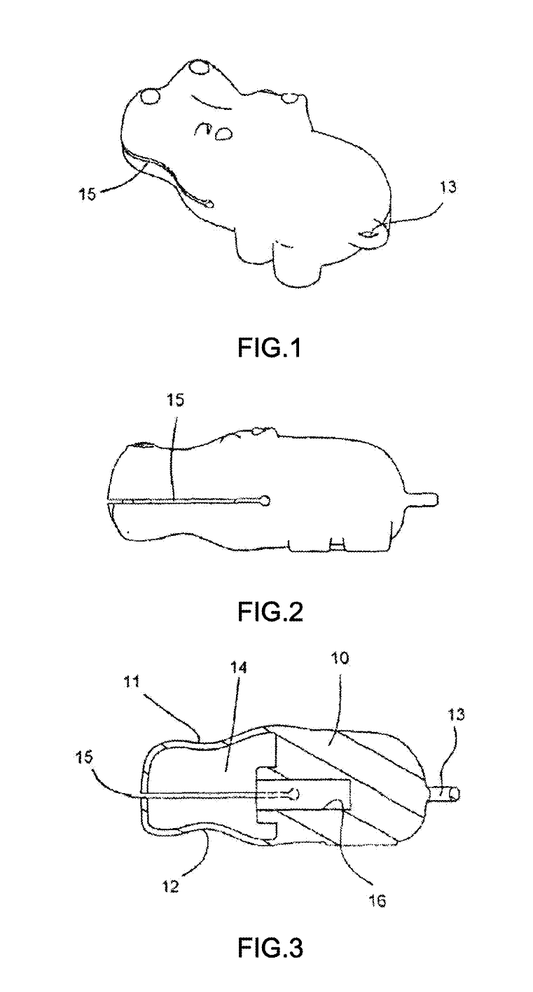

With reference to FIGS. 1 to 4 for a multi-shape memory container of the present invention, the multi-shape memory container is made of soft silicone. In FIG. 1, the memory container is in a shape of a hippopotamus, wherein the body of the hippopotamus is designed as the body of a memory product, the mouth at the front end of the body is formed by a first cover board (11) and a second cover board (12), and a slot (15) is formed between the first cover board (11) and the second cover board (12) to define a range for flipping open the first cover board (11) and the second cover board (12), and a receiving space is formed inside the first cover board (11) and the second cover board (12) within the body (10), and the body (10) has a recessed cavity (16) formed at the receiving space (14) and the slot (15) is aligned precisely with the recessed cavity (16), and the rear end of the slot (15) is disposed in the recessed cavity (16).

A hole (13) is formed and protruded outwardly from the body (10) and provided for hanging the memory product on a keychain, a decorative item, a purse, or a belt.

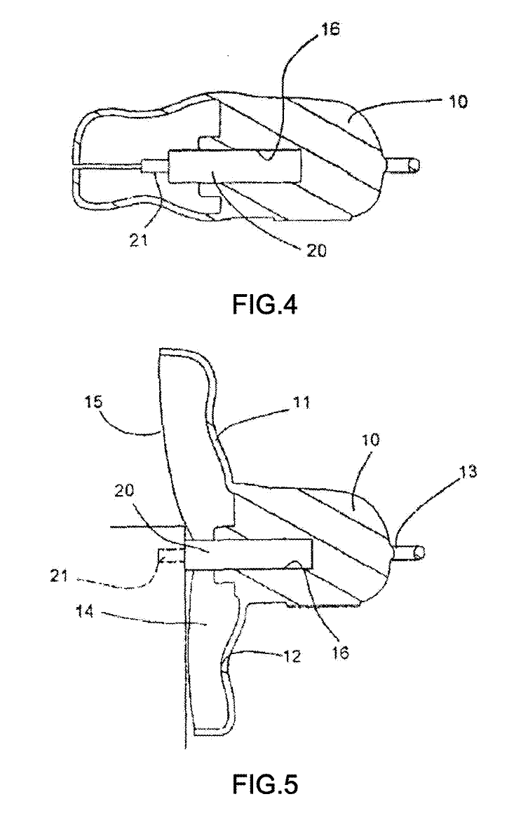

With reference to FIG. 4 for a memory product (20) placed in the recessed cavity (16), the USB connector (21) is disposed outside the recessed cavity (16), and the recessed cavity (16) made of soft silicone has specific elasticity and compressibility and can securely fix the memory product (20) in the recessed cavity (16) without the risk of being loosened or falling out easily.

When use, the first cover board (11) and the second cover board (12) can be flipped open from both sides by the design of the slot (15) to expose the USB connector (21) for using a related transmission device such as a computer, a printer, or a videotape recorder.

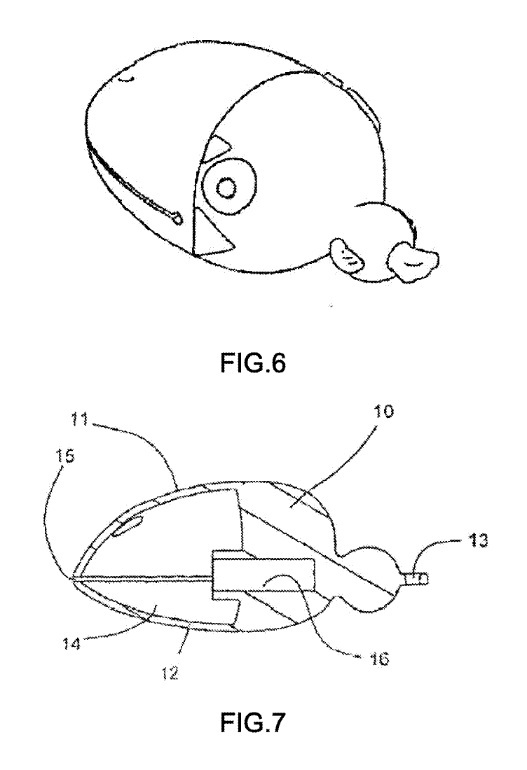

In summation of the description above, the present invention not only allows a user to change the body of the memory container into different shapes according to the user's personal. In FIGS. 6 and 7, the body of the memory container is in the shape of a bird. In addition, the present invention provides a convenient carry and overcomes the problems of the prior art such as losing or missing the USB cover and complies with the patent application requirements and thus is dually filed for patent application.

What is claimed is:

1. A multi-shape memory container, comprising:
a body (10), made of soft silicone, and having a recessed cavity (16) formed thereon for embedding a memory product (20) therein;
a first cover board (11) and a second cover board (12), formed on both sides of a front end of the body (10) respectively to define a receiving space (14) therein; and
a slot (15), formed between the first cover board (11) and the second cover board (12).

2. The multi-shape memory container of claim 1, wherein the body (10) has a hole (13) outwardly protruded from an end of the body (10).

3. The multi-shape memory container of claim 1, wherein the slot (15) has a rear end precisely aligned with the recessed cavity (16).
